(19) United States
(12) Patent Application Publication
(10) Pub. No.: US 2015/0016494 A1
(43) Pub. Date: Jan. 15, 2015

(54) PHASE DISCONTINUITY TESTER FOR MULTI ANTENNA TRANSMITTERS SENDING PHASE PERTURBED SIGNALS

(71) Applicant: GOOGLE INC., Mountain View, CA (US)

(72) Inventor: Sherwin Wang, Towaco, NJ (US)

(73) Assignee: GOOGLE INC., Mountain View, CA (US)

(21) Appl. No.: 14/376,904

(22) PCT Filed: Feb. 4, 2013
(86) PCT No.: PCT/US13/24616

§ 371 Date: Aug. 6, 2014

Related U.S. Application Data
(60) Provisional application No. 61/597,015, filed on Feb. 9, 2012.

(51) Int. Cl. H04B 17/00; H04B 7/06

(52) U.S. Cl. CPC H04B 17/0017; H04B 7/06
USPC 375/226

(57) ABSTRACT

A tester for determining phase discontinuity is described for a transmitter having multiple antennas sending signals to a receiver. Typically the transmitter is provided in a mobile telephone and the receiver is in a base station. The transmitter sends out the RF signals in a shaped beam using transmission diversity. The RF signals define multiplexing slots. The tester receives the RF signals as they are fed to a respective antenna port, analyses phases of these signals on a slot-by-slot basis comparing phase differences between adjacent slots to a threshold derived from legacy devices.

### CROSS REFERENCE TO RELATED APPLICATIONS

This application claims priority to U.S. provisional patent application Ser. No. 61/597,015, filed on Feb. 9, 2012, which is incorporated herein by reference in its entirety.

### TECHNICAL FIELD

This disclosure relates generally to the field of wireless communications and more specifically to a tester detecting phase discontinuity in phase perturbed signals from a multi antenna transmitter.

### BACKGROUND

A modifying communication device (such as a user device UE) has a transmitter that includes multiple antenna elements transmitting signals to communicate information. A receiving communication device (located typically at a base station) extracts information from the transmitted signals. The multiple antenna elements enhance spectral efficiency, allowing more users to be served simultaneously over a given frequency band. The transmitted signals, however, propagate along different paths and may reach the receiving communication device with different phases that destructively interfere. It is generally desirable to apply a relative phase difference between the two transmit signals to compensate for the phase difference due to the different paths or fading so that constructive interference can be achieved at the receiver. A phase perturbation method may be used to derive the proper applied phase for obtaining constructive interference at the receiver.

The phase perturbation method includes perturbing the nominal value of the phase difference of two transmit diversity antennas continuously in alternating directions. In one technique, referred to as OLTD (Open Loop Transmission Diversity) it is assumed that the receiving communication device is capable of detecting the received signals without any further information from the modifying communication device and can return a feedback parameter such as TRP (Total Radiated Power). In another technique, referred to as CLTD (Closed Loop Transmission Diversity) the receiving device can distinguish the signals from each sending antenna and return either a feedback parameter TRP or send back (typically over a secondary channel) instructions how to adjust the phase in the modifying communication channel. In both cases this feedback parameter is used to adjust the nominal valued of the phase difference so as to achieve constructive interference of the signals.

One problem with the above-described methods is that the dynamic phase adjustment of the transmitted signals may result in undesirable phase discontinuities in the received combined signals. In order to eliminate, or at least reduce such discontinuities, a beam forming technique has been suggested in which the relative phases between the two transmit signal are adjusted such that half of the phase is applied to one transmit signal and the other half of the phase is applied to the other transmit signal in the other direction. Thus, if at a given instance, a phase change φ is required, the phase of one of the transmit signals is increased by φ/2 and the phase of the other transmit signal is decreased by φ/2. This technique is referred to as a symmetric phase implementation. Ideally, even though the relative phase between the two transmit signals may vary from one time slot to the next slot, the net phase discontinuity of the combined signal at the receiver should always be zero. Hence there is no phase discontinuity from one slot to the next slot due to the relative phase applied dynamically to the transmit signals. However, in reality, the net phase discontinuity of the two signals sensed at the receiver is often not zero because of various effects taking place in the transmitter, and the user equipment must test for such phase discontinuity.

### SUMMARY

A tester for determining phase discontinuity of RF signals generated by a transmitter is presented. The transmitter has at least two antennas, the antennas having antenna inputs receiving RF signals. The RF signals define successive multiplexing slots, and are preferably modulated using a symmetric transmission diversity protocol. The tester includes a comparator detecting a difference signal indicative of a phase discontinuity in said signals during a particular slot n and a preceding slot n−1. The comparator further compares the difference signal to a threshold.

The tester further includes a detector that analyzes an output of the comparator for a plurality of slots. The detector then generates an output indicative of phase discontinuity based on the analysis of the detector.

In one embodiment, the tester includes a local oscillator generating test signals corresponding to each RF signal. The test signals provide a reference for comparing an instantaneous phase of said RF signals during each of said slots.

In another embodiment, the tester of claim 1 includes a summer for summing the RF signals. The summer generates a phase signal indicative of the mathematical sum of the phases of said RF signals for each interval. This phase signal is then compared to a legacy threshold. The detector analyzes the results from the comparator for a plurality of slots to determine an overall phase discontinuity parameter for the tester.

### BRIEF DESCRIPTION OF THE DRAWINGS

For a more complete understanding of the subject device and method and its features and advantages, reference is now made to the following description, taken in conjunction with the accompanying drawings, in which:

FIG. 1 is a block diagram illustrating an example of a modifying communication device that adjusts a nominal value of a transmit diversity parameter, and includes a test section for testing the amplitudes of phase disturbances in the output signal;

FIG. 2 shows a block diagram for one version of the test stage; and

FIG. 3 shows a block diagram for a second version of the test stage

### DETAILED DESCRIPTION

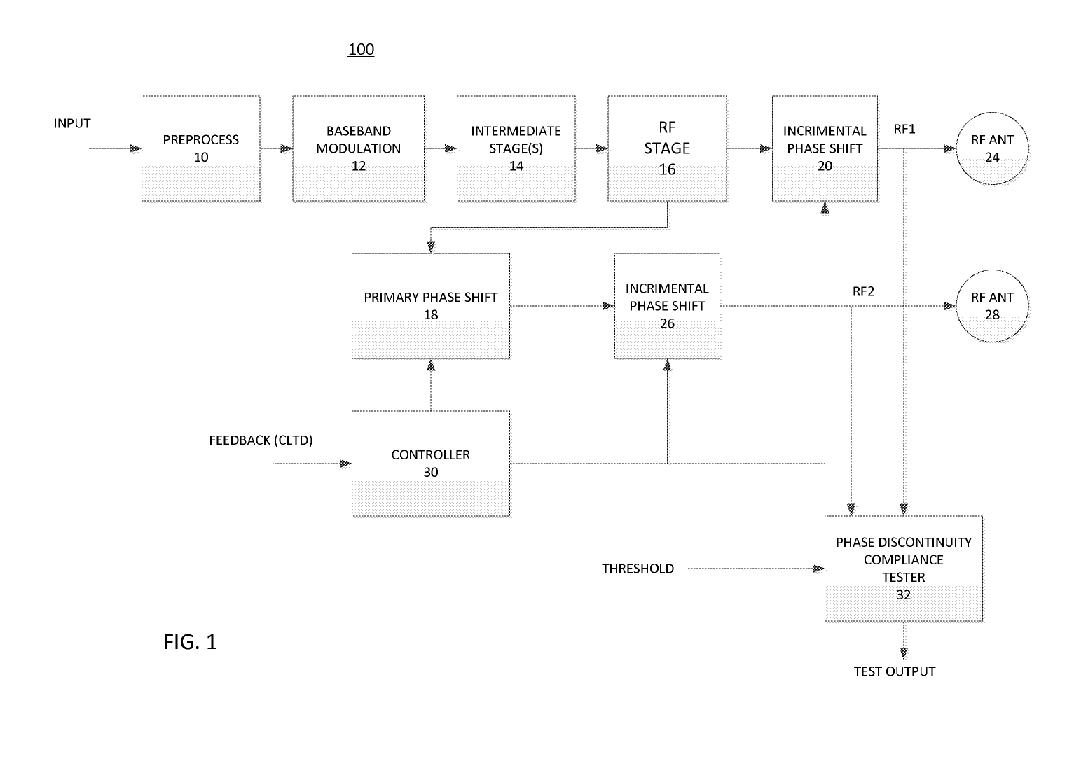

FIG. 1 shows a block diagram illustrating one example of a communication device 100 and an associated test equipment. Device 100 may be, for example, a mobile phone. The device includes a preprocessing stage 10 which receives the input signal that needs to be transmitted and performs various manipulations on this signal. For example, the input signal may be combined from different channels using one or more multiplexing techniques, such as TDM, FDM, CDM, PDM, etc. In addition, the input signal may be encoded for error detection and/or may be encrypted so that it cannot be read by unauthorized parties. Other types of processing may also be performed at stage 10. The preprocessed signal may be a digital signal that is then modulated by the baseband modulation stage 12. One or more intermediate stages 14 are next used to process the modulated signal from stage 12, either in the base band frequency range or at an intermediate frequency range. Next, an RF stage 16 converts the output of stage 14 to the RF frequency domain and may include amplifiers, filters, etc.

The output of stage 16 is then provided to an incremental phase shift stage 20. The resulting signal RF1 is then provided to a first antenna 24 which then sends the signal RF1 on to the receiving communication device (for example a base station—not shown).

The output of RF stage 16 is also provided to a primary phase shifter 18. This primary phase shifter shifts this output by 180 degrees, if device 100 has two transmit antennas. The device 100 can have more than two transmit antennas, in which case more than one principal phase shift stage is used, each such shift stage shifts the output of the RF stage by a predetermined amount.

The output of the primary phase shift stage 18 is then provided to a second incremental phase shift stage 26. The output of the second phase shift stage is provided to a second RF antenna 28.

A controller 30 is also provided in the device 100. As mentioned above, in both open loop (OLTD) and a closed loop transmission diversity (CLTD) the transmitter receives a feedback signal from the receiver device providing a parameter indicative of a characteristic of the signal received from device 100. For example, this feedback signal may be TRP (Total Radiated Power). The controller 30 generates control signals for the incremental phase shift stages 20, 26 that determine how phase shift is required for various transmit diversity (TD) techniques. For example, in a symmetrical TD technique, both signals are shifted simultaneously by a predetermined value, but with opposite phase (i.e. one increasing and the other decreasing). In an enhanced symmetrical TD technique, the shift stages 20, 26 are required to shift the signal phase by an incremental absolute amount sequentially until a maximum phase shift is achieved, and the process may then be reversed and the phase decremeted.

As previously mentioned, device 100 generates RF1, RF2 that are presented to the inputs of antennas 24, 28 respectively for transmitting the same to remote locations, such as a receiving device at a base station (not shown). Because of various effects within the device 100, including the symmetrical phase perturbations, the signals sensed by the antenna at the base station (not shown) even when they are added, may have an undesirably high phase discontinuity. Therefore, the device 100 has to be tested to determine whether it is the source of such a discontinuity. If it is, then its design and/or operational parameters must be changed to eliminate this discontinuity.

FIG. 1 shows a tester 32 that may be configured to determine the phase discontinuity if any and compliance with predetermined regulations. More specifically, in this disclosure, a parameter associated with an instantaneous phase change in signals RF1, RF2 is compared to a legacy threshold value. Such a legacy threshold value may be determined from various previous legacy devices. The tester then generates an output that selectively may provide information either only indicating compliance or not and/or displaying measurements obtained by the tester. Importantly, tester 32 receives the signals RF1 and RF2 just as they are fed to the antennas 24 and 28, respectively.

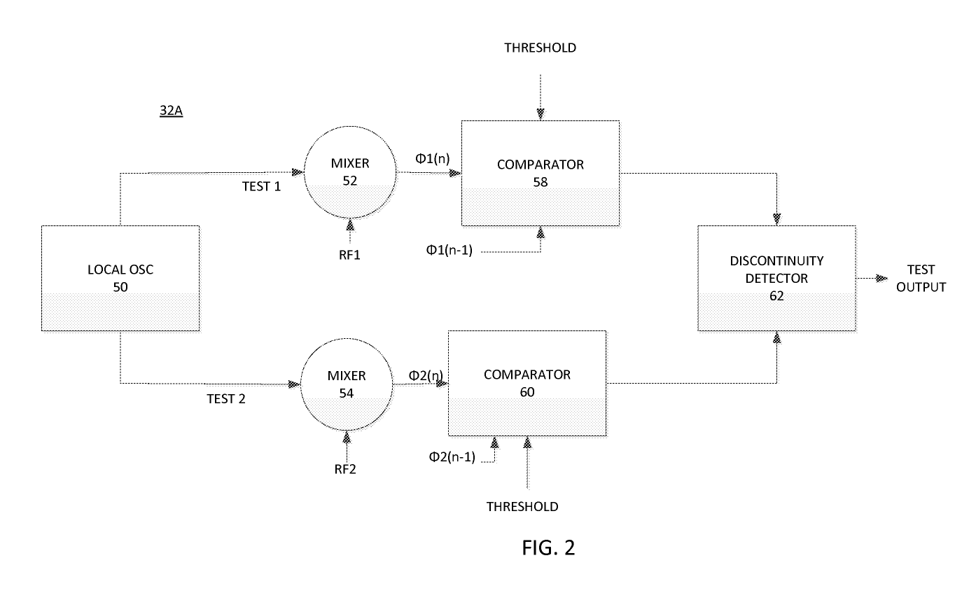

FIG. 2 shows one implementation of tester, designated tester 32A. In this version, the tester 32A includes a local oscillator 50 generating two test signals TEST1 and TEST2 (normally in the RF range). TEST2 is phase shifted from TEST1 by 180 degrees. The TEST signals define a phase reference during each slot that is used to determine the instantaneous phase of each RF signal during said slot.

TEST1 is provided to a first mixer 52 that mixes it with signal RF1. Similarly, TEST2 is provided to a second mixer 54 for mixing with signal RF2. This process is performed simultaneously for each signal RF1 and RF2. As previously presented, signals RF1 and RF2 are multiplexed signals consisting of a sequence of slots, such as slots n−2, n−1, n. The phases of the mixed signals (after appropriate filtering, if necessary) φ1 (n), φ2(n) are indicative of the phase differentials between signals RF1, RF2 and signals TEST1, TEST2 as measured during slot n. Signals φ1(n), φ2(n) are provided to two respective comparators 58, 60. These comparators perform two functions. First, they determine difference signals DF1(N)=φ1 (n)−φ1(n−1); and DF2(N)=φ2 (n)−φ2(n−1), respectively. Then they compare these signals to the

THRESHOLD parameter. The results are provided to an instantaneous phase discontinuity detector 62. Detector 62 analyzes the results from comparators 58, 60 and determines whether either or both are indicative of an excessive phase discontinuity or not and generates a respective TEST OUTPUT signal. Since, in a typical transmission, the signals RF1 and RF2 include a large number of intervals, the detector may be adapted to average the values obtained for each interval, and analyze only the intervals with the largest phase discontinuities, etc.

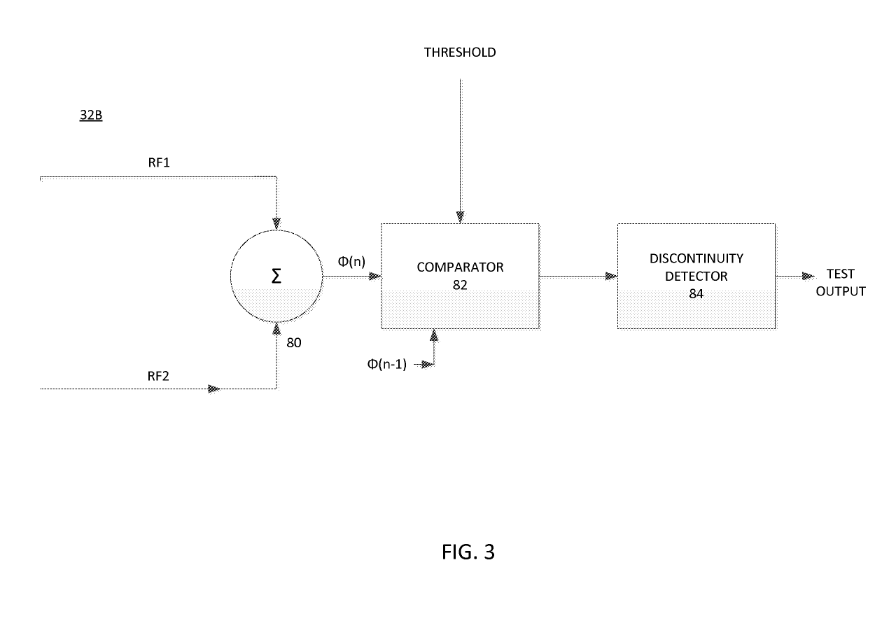

FIG. 3 shows another implementation for the tester. In this implementation, tester 32B includes a summer 80 that sums the two signals RF1, RF2 during a particular slot n. The phase of the resulting sum φ(n) is provided to a comparator 82 which first generates a difference signal DF(n)=φ(n)−φ(n−1), where φ(n−1) is the phase obtained from summer 80 during slot n−1. Then the comparator compares this difference DF with the THRESHOLD. The results of the comparison are analyzed and used to generate the TEST OUTPUT signal. Again, since there are a large number of slots, the detector 84 may analyze the results from the slots, and calculate an average discontinuity, a peak discontinuity, etc.

While certain features of the subject device and method have been illustrated and described herein, many modifications, substitutions, changes. And equivalents will now occur to those skilled in the art. Therefore it is to be understood that the appended claims are intended to cover all such modifications and changes as they fall within the scope of the attached claims.

I claim:

1. A tester for determining phase discontinuity of RF signals generated by a transmitter having at least two antennas, the antennas having antenna inputs receiving the RF signals in the RF frequency range, the RF signals defining successive multiplexing slots, the RF signals being modulated using a symmetric transmission diversity protocol, said tester comprising:
a comparator detecting a difference signal indicative of a phase discontinuity in said signals during a particular slot and a preceding slot and comparing said difference signal to a threshold; and
a detector analyzing an output of said comparator for a plurality of slots and generating an output indicative of phase discontinuity based on said analysis.

2. The tester of claim 1 further comprising a local oscillator generating test signals corresponding to each RF signals, said test signals providing a reference for comparing an instantaneous phase of said RF signals during each of said slots.

3. The tester of claim 1 further comprising a summer for summing said RF signals and generating a phase signal indicative of the mathematical sum of the phases of said RF signals for each interval.

4. The tester of claim 1 wherein said threshold is based on threshold values obtained from legacy devices.

5. A method for determining phase discontinuity of RF signals generated by a transmitter having at least two antennas with antenna inputs receiving respective RF signals, the RF signals defining successive multiplexing slots, the inputs being modulated using a symmetric transmission diversity protocol, said method comprising:
generating a difference signal for each slot, said difference signal being indicative of a phase discontinuity in said signals between a particular slot and a preceding slot;
comparing said difference signal to a threshold;
analyzing results of said comparison for a plurality of slots; and generating an output indicative of phase discontinuity in said transmitter.

6. The method of claim 5 further comprising generating test signals for said RF signals, said test signals defining reference phases during said slots; and
using said reference signals to determine the instantaneous phase of said signals within said slots.

7. The methods of claim 5 further comprising summing said RF signals and determining a phase signal of the sum during each slot.
